(19) United States
(12) Patent Application Publication
(10) Pub. No.: US 2025/0260562 A1
(43) Pub. Date: Aug. 14, 2025

(54) Networks Comprising Multi-Quantum Blockchain Systems, Methods, And Products

(71) Applicant: Timothy Edgin, Houston, TX (US)

(72) Inventor: Timothy Edgin, Houston, TX (US)

(21) Appl. No.: 18/438,431

(22) Filed: Feb. 10, 2024

(51) Int. Cl. H04L 9/08; G06F 40/20

(52) U.S. Cl. CPC H04L 9/0852; G06F 40/20

(57) ABSTRACT

Systems, methods and products for blockchain distributed networks, including software defined networks, are provided, that include a management plane blockchain for distributing public keys and other management functions, a control plane blockchain for configuring how to communicate data, and a data plane blockchain to communicate data, including private keys, that each interact with artificial intelligence and use quantum generated random numbers for encrypted keys and other processes, and which can be controlled by human users, artificial intelligence users, or a combination of both users.

### FIELD OF THE INVENTION

The invention relates to networks comprising multi-quantum blockchains.

### BACKGROUND OF THE INVENTION

Blockchain is a common database, ledger, or database of many transactions that are saved on multiple points in different locations. The chain grows when new transactions or “blocks” are added to it. This may form a chain of data where records are public and verifiable. However, there are problems associated with the current systems, methods, and products used with blockchain distributed networks. These include problems with hacking and security, including regarding authentication of users and use of encryption keys, including public keys. It is anticipated that these problems will only get worse with expected attacks from quantum computers. New and improved systems, methods, and products are needed to have and maintain reliable and secure blockchain distributed networks.

### SUMMARY OF THE INVENTION

Certain embodiments of this invention provide systems, methods, and products for blockchain distributed networks, including software defined networks (SDN). Components that provide these systems, methods, and products comprise multiple blockchains created using different algorithms: at least one blockchain for a management plane, one blockchain for a control plane, and one blockchain for a data plane. The management plane blockchain is used to distribute public keys (which are shown only to authorized users and not the public in some embodiments) and other management functions, such as creating policies to be voted on in the lower chains. The control plane blockchain (the middle chain) is used to make decisions and configure how to communicate data. The data plane is used to carry or communicate (traffic) data, including private keys, to users. Artificial intelligence (AI) (e.g., preferably Large Language Models (LLM) with Retrieval Augmented Generation (RAG)) and applications are available to manage the blockchains, the keys, and the voting processes (e.g., consensus or threshold votes for multi-factor authentication). Quantum generated random numbers (e.g., preferably Very Large Numbers (VLN) using qubits to generate random VLN using quantum measurements (e.g., quark top-spin)) are used for the encrypted keys that are generated for the blockchains, thus providing protection for each of the blockchains. Thus, the blockchains can be controlled by human users, AI, or a combination of human users and AI and embodiments can be created to be a completely autonomous system, method and product.

Certain preferred embodiments of this invention comprise systems for providing a software defined network comprising multiple blockchain distributed ledgers and communication with artificial intelligence. The systems can be interacted with by humans and/or artificial intelligence. The systems comprise computer readable instructions and the instructions create and/or communicate with a number of components. The components comprise (a) a management plane blockchain that is created that distributes to the network public keys and policies that are voted on and which provides management instructions to a control plane blockchain; the control plane blockchain which is created that configures how to communicate data within the network in response to management instructions from the management plane blockchain; a data plane blockchain that is created that communicates data, including private keys, according to the configuration provided by the control plane blockchain; (d) artificial intelligence that is created or communicated with that can interact with one or more of the processes of blockchains of the network, including the public keys, the private keys, and any voting process; (c) a quantum random number generator that is created or communicated with that generates Very Large Numbers that are used for generating at least the public keys and private keys; and (f) wherein the blockchains and/or processes within each blockchain can be controlled by human users, the artificial intelligence, or a combination of human users and artificial intelligence.

In certain of these preferred embodiments, qubits generated by quantum measurements are used in the quantum number generator. In addition, in certain of these preferred embodiments, the quantum random number generator is located in a blockchain of the network. Furthermore, in certain of these preferred embodiments, the artificial intelligence is uses Large Language Models and Retrieval Augmented Generation.

Certain other preferred embodiments of this invention comprise methods for providing a software defined network comprising multiple blockchain distributed ledgers and artificial intelligence. Humans and/or artificial intelligence can interact with these methods. These methods comprise providing computer readable instructions. These the instructions (a) create a management plane blockchain that distributes to the network public keys and policies that are voted on and which provides management instructions to a control plane blockchain; (b) create the control plane blockchain that configures how to communicate data within the network in response to management instructions from the management plane blockchain; (c) create a data plane blockchain that communicates data, including private keys, according to the configuration provided by the control plane blockchain; (d) communicate with (or create) artificial intelligence that can interact with one or more of the processes of blockchains of the network, including the public keys, the private keys, and any voting process; (c) communicate with (or create) a quantum random number generator that generates Very Large Numbers that are used for generating at least the public keys and private keys; and (f) wherein the blockchains and/or processes within a blockchain can be controlled by human users, the artificial intelligence, or a combination of human users and artificial intelligence.

In certain of these preferred methods qubits generated by quantum measurements are used in the quantum number generator. In addition, in certain of these preferred methods a quantum random number generator is used that is located in a blockchain of the network. Furthermore, in certain of these preferred methods artificial intelligence that uses Large Language Models and Retrieval Augmented Generation is used.

Certain other preferred embodiments of this invention comprise computer program products for providing a software defined network comprising multiple blockchain distributed ledgers and communication with artificial intelligence. The network can be interacted with by humans and/or AI. These products comprise computer readable instructions. These instructions create and/or communicate with a number of components. These components comprise: (a) a management plane blockchain that is created that distributes to the network public keys and policies that are voted on and which provides management instructions to a control plane blockchain; (b) the control plane blockchain that is created that configures how to communicate data within the network in response to management instructions from the management plane blockchain; (c) a data plane blockchain that is created that communicates data, including private keys, according to the configuration provided by the control plane blockchain; (d) artificial intelligence that is created or communicated with that can interact with one or more of the processes of blockchains of the network, including the public keys, the private keys, and any voting process; (e) a quantum random number generator that is created or that communicates with that generates Very Large Numbers that are used for generating at least the public keys and private keys; and (f) wherein the blockchains and/or processes within a blockchain can be controlled by human users, the artificial intelligence, or a combination of human users and artificial intelligence.

In certain of these preferred products qubits generated by quantum measurements in the quantum number generator are used. In addition, in certain of these preferred products a quantum random number generator that is located in a blockchain of the network is used. Furthermore, in certain of these preferred products artificial intelligence that uses Large Language Models and Retrieval Augmented Generation is used.

Applications for the embodiments of this invention include improving the processing and analysis of data, the application of Smart Contracts, and the authentication accuracy and experience of a user logging on to a system and other authentication and verification uses. The person of skill in the art understands how this application and combining of this invention can be done with additional applications. Applications of this invention include but are not limited to financial transactions, supply chain records, healthcare, cybersecurity, and personal identity, among others.

Advantages of the embodiments of this invention are described and apparent throughout this specification. For example, certain embodiments will enhance a resource's security by ensuring that users are reliably authenticated. Previous techniques for authentication included usernames and passwords, but these are vulnerable to brute force attacks and can be stolen by third parties. Certain embodiments of this invention solve this problem and they are not vulnerable, or as vulnerable, to such brute force attacks.

This invention also provides excellent data security and integrity due to its decentralized architecture. Blockchain hashing technology stores information securely on its ledger. This invention lacks or removes critical points of attack for hacking and entering into systems, reducing database breach threats. Furthermore, because information is decentralized on the blockchain ledger, the blockchain gives its end users more control over their digital information. Little to no fraud is committed on blockchain networks because of the immutability they provide and the lack of the ability to tamper with data. The blockchain aspects of this invention also allow transactions between multiple parties without the involvement of third parties and the sensitive information is kept on multiple nodes on the network instead of being kept in one centralized database that is more sensitive to tampering. The use of AI with this invention further enhances the advantages of this invention, providing data analysis and processing and Smart Contract capabilities, and increasing the reliability of the authentication and its usability by learning what factors to apply in different situations and enhancing the detection and response to threats. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic of aspects of certain embodiments of this invention, illustrating components of a system and product and information flow in a method.

### DETAILED DESCRIPTION OF THE INVENTION

Blockchain is a distributed and generally immutable ledger of transactions. Each block in a blockchain contains records of one or more transactions and points to the prior one. Transaction records can be securely saved and validated in an untrusted peer-to-peer system by applying a consensus mechanism in a decentralized manner. The consensus mechanism confirms that the majority of peers can reach an agreement on the transaction records disseminated over the network using protocols. Transactions can implement and execute the operational codes saved in a blockchain, enabling, for example, Smart Contracts.

By leveraging blockchain, embodiments of this invention can provide dynamic access control, confirm the integrity and validity of data, and preserve privacy of a network, including a software defined network. The blockchains may also be integrated to provide synchronization among different network elements equipped with storage, computing, and networking management and control of resources.

Certain embodiments of this invention comprise systems, methods, and products that create new networks such as Software Defined Networking (SDN). In this networking, network layers (e.g., SND layers) are separated and put into different blockchain distributed ledgers. Generative AI (e.g., Large Language Models (LLMs) enhanced with Retrieval Augmented Generation (RAG)) and quantum randomized numbers are used to enhance and manage the layers and blockchains.

In particular, these layers and blockchains are each protected by quantum generated random Very Large Numbers (VLNs) serving as key generators to provide extremely large rotating keys for the lower blockchains. In preferred embodiments, qubits are used as the random number generators. In certain of these preferred embodiments, the qubits are generated by a quantum measurement (e.g., quark top-spin). The resulting encryption keys are then used in the separate layers and blockchains, resulting in new blockchain-based protections for networks and data, such as SDN and SDN data.

Planes (or logical entities) are integral components of the networks of this invention and each represent a different area of network operation, carrying different types of network traffic. A management plane, a control plane, and a data plane are each created by the systems, methods and products of embodiments of this invention with different blockchains using different algorithms. The management plane blockchain acts as a controller and it distributes public keys (which are shown only to authorized users and not the public in some embodiments) and performs other management functions (e.g., creates policies to be voted on in the lower blockchains). The control plane blockchain is a middle blockchain that makes decisions and configures how to transfer or communicate or traffic data. The data plane blockchain is a lower blockchain that carries (communicates or traffics) data according to the configurations set by the control plane, including private keys, to users. A quantum blockchain or module is also used in some embodiments to generate the extremely large rotating keys to the lower chains.

In particular, operations such as Smart Contracts, which are simple logical bits of programs stored on each block of blockchain that run when certain conditions are met, are part of the blockchains. Smart Contracts follow “if/when . . . then . . . ” statements written on the blockchain and help automate the verification involved with authentication. The automatic execution of the requirements ensure the outcome is correct and the irreversibility and traceability of each transaction increases the trust in the outcome. Smart Contracts make faster and better decisions that save time, lower cost and lower risk. They may be managed by humans, AI or both.

Private and public keys, and digital signatures, used by the blockchains of embodiments of this invention are generated by quantum cryptography. In particular, quantum generated random VLNs serve as key generators to provide extremely large rotating keys for the lower blockchains. In preferred embodiments, qubits are used as the random number generators. In certain of these embodiments the qubits are generated by a quantum measurement (e.g., quark top-spin). The resulting encryption keys and digital signatures are then used in the separate layers and blockchains, resulting in blockchain-based protections for user authentication, networks and data, such as SDN and SDN data. For example, these same random number generators are used in embodiments of this invention to produce unbiased and unpredictable randomness with the blockchains, as needed for particular applications (e.g., Smart Contracts).

The AI part of embodiments of this invention provides intensive and sophisticated processing of information such as authentication data in real-time. AI can be applied to a variety of blockchain operations including monitoring malicious behavior and improving authentication and security results (e.g., applying unsupervised clustering-based procedures and architecture to analyze generated data such as malicious behavior); performing data analysis and providing data visualization (e.g., charting); translating data to comparable forms (e.g., converting data in different forms or from physical systems); applying Smart Contracts; detecting anomalies in network layers and blockchains; automate machine learning; assist and perform voting and making collective decisions; connecting the network to smart products, cloud services, person-to-person systems, authorized users; etc.).

In general, the decentralized, deterministic, immutable, high integrity and attack resistant blockchains and their processes can benefit from the centralized, changeable, probabilistic, volatile, data-centric, knowledge-centric, decision-centric nature of AI by (1) enhancing security, (2) improving automated decisions, (3) improving and organizing collective decision making and voting, and (4) increasing efficiency from supervised and unsupervised learning.

For example, if a user tries to log into a system from New York City, then five minutes later attempts to log in from Moscow, AI can be used to identify the problem of a person appearing to be in two places at once. In this example, the AI assesses and weighs individual factors from the login attempt and creates a risk score. If the score is too high, the AI may be used to deny the user access altogether. If the score is lower, the AI may suggest additional factors for the user to provide before access is granted. Some scores can be determined to justify providing the user immediate access.

In certain embodiments, the AI monitors and collects a number of factors concerning a user and the user's past login attempts and builds a profile for the user. These factors can include the user's location, the user's network and its reliability, the user's device, the time of login, etc. When faced with a new login attempt by someone who appears to be the user, the AI can compare that new login attempt with previous attempts and the profile the AI created or was provided. If the comparison shows too much variability, the login attempt may be denied outright. With less variability, the AI may request additional authentication information from the user before access is granted. With even less variability, the AI may grant immediate access.

In this example, the AI-powered authentication can identify low-risk users and make their login attempts faster and less obtrusive. The AI can also identify high-risk users and login attempts and only then slow down the process and collect additional authentication factors, making the authentication process more rational and less intrusive when it can be.

The more it is used, the more the AI can protect the system without slowing users down. At first, the AI may just compare a few factors, but as it collects more information, using unsupervised learning it may find new patterns to use to make increasingly good predictions. The AI may cross-reference different machine learning algorithms using pattern recognition and leverage time-based predictive algorithms to improve the accuracy and scope of its predictions.

The AI provides a record of what data went into a given decision and the number of factors that were considered and thus the system can be reviewed and tailored to, and refined by, the actual environment of the use. The AI can also use information from third parties concerning past threats and stolen credentials of particular users, and other such relevant information, all in real time, to evaluate risk.

Embodiments of this invention may include one or more AI configuration engines comprising computer readable code stored on a non-transitory computer-readable medium. This AI engine can automate processes on a blockchain distributed ledger. This AI in one or more engines, when executed by a computer system(s), may (1) operate or facilitate the processes on one or more nodes on a blockchain distributed ledger (e.g., AI models embedded in Smart Contracts executed on a blockchain), and/or (2) be used in the authentication process of this invention to ingest authentication factors and other information from or pertaining to data, users (e.g., log in information, query responses, patterns from past behavior, stored information on the user in a database), ingest the results of voting by nodes in a blockchain distributed ledger, optionally ingest AI and/or human feedback on authentication factors and the other information from users and other blockchains, and/or dynamically correlate authentication factors with voting results and any feedback results to train on, update and/or suggest which authentication factors and other information are likely to obtain which voting results or to be security risks.

Preferred embodiments of this invention include supervised and/or unsupervised learning models using AI that that processes, trains on, updates, and/or suggests which authentication factors, data, and other information from other blockchains, users (e.g., logging on information input from the user or the user's computer), or pertaining to users (e.g., from a database with data keyed to a user) is relevant to the data and other processes (e.g., authentication of the users in obtaining access to resources such as computer applications). For example, a user's address or other attribute may be associated with a higher level of trust in authentication as learned by AI that informs the system.

Certain preferred embodiments of this invention use large language models (LLMs) types of AI algorithms that use deep learning techniques and can use large data sets to understand, operate (e.g., apply Smart Contracts), summarize, generate and predict new content. Particular transformer models are capable of generating accurate responses rapidly, for example.

The inputs of this information may be provided by the user using a computer device (e.g., mobile phone, laptop computer and keyboard, scanned driver's license, camera (e.g., facial recognition, fingerprint). The inputs may also come from a database of information pertaining to the user. The inputs may also come from or multiple sources (e.g., inputs and databases) and are most preferably from other blockchains. The inputs are then uploaded to a cloud-based or other network based computer automatically by systems of these embodiments. The inputs are stored and processed in computer readable memory and processors that execute instructions, which may include Smart Contracts and other aspects of blockchain distributed ledgers. The outcome of the processing can be used by the blockchain in voting, Smart Contracts, and/or otherwise provided to a system or person for training, updating and/or modifying the system (e.g., on how to weigh authentication requirements and factors). Other inputs can be from instances when a user should not have been granted access, law enforcement, etc., and the authentication was faulty, or some other event, and thus they can be used to train, update and/or modify the system. The AI can be used in supervised and unsupervised learning models in the manner set forth above to process large quantities of inputs and identify patterns in the inputs to predict anomalies and results.

User information (e.g., from logging on (e.g., the user's device, time, place)), from authentication factors provided by the user, or databases pertaining to the user, or other data for other processes than authentication, may be stored as database objects (DBOs). The DBOs may be arranged in a set of logical tables containing data fitted into predefined or customizable categories, and/or the DBOs may be arranged in a set of blockchains or ledgers wherein each block (or DBO) in the blockchain is linked to a previous block. Each of the DBOs may include data associated with individual users, such as biographic data collected from individual users; biometric data collected from individual users; data collected from various external sources; identity session identifiers (IDs); AI generated information; identity scores, survey assessment scores, etc.; and/or other like data. Some of the DBOs may store information pertaining to relationships between any of the data items discussed herein. Some of the DBOs may store permission or access-related information for each user. These DBOs may indicate specific third parties that are permitted to access identity data of a particular user. In some implementations, the permission or access-related DBOs for each user may be arranged or stored as a blockchain to control which third parties can access that user's identity data. In these embodiments, the blockchain(s) do not actually store user biometric and/or biographic data, but instead are used to authorize specific third party platforms to access specific identity data items and to track or account for the accesses to the identity data items.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

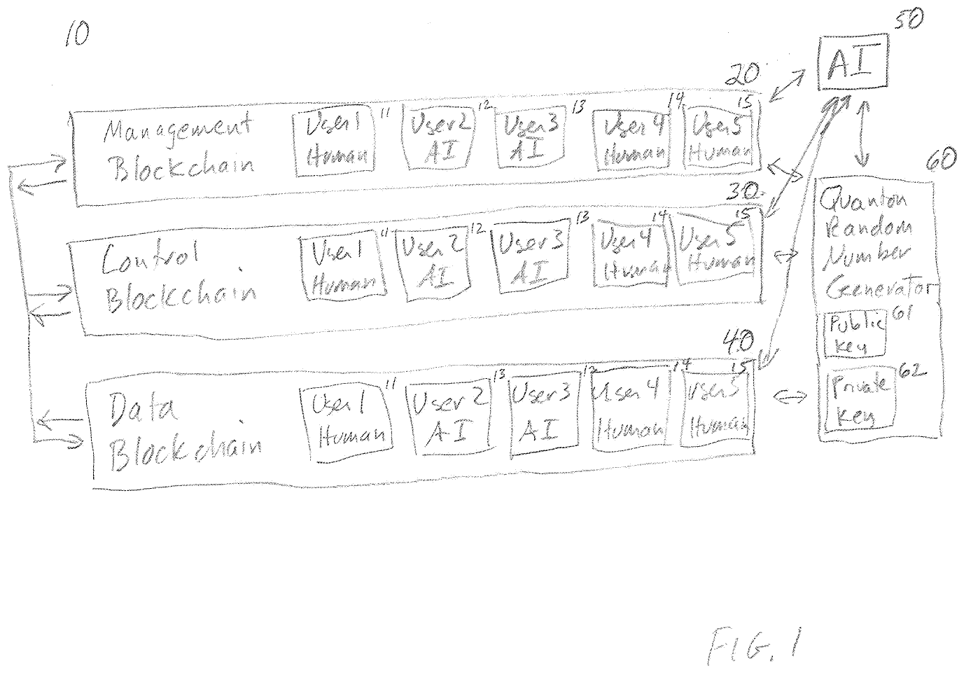

As illustrated by FIG. 1, a system, method or product of this invention may comprise components and information flows that form a Software Defined Network. This embodiment shown 10 has three blockchains, a management layer blockchain 20, a control layer blockchain 30, and a data blockchain 40. Each of the blockchains has five users in this example, three of which are humans 11, 14, and 15 and two of which are AI 12, 13. The three blockchains interact with each other and with AI 50 and a quantum random number generator 60, that may generate a public key 61 (stored in the management layer blockchain 20) and a private key 62 (stored in the data layer blockchain 40). In this embodiment, among other processes, the management layer blockchain 20 manages the control layer blockchain 30 and the public key 61. The control layer blockchain 40 provides the configuration for any data transfer. The data layer blockchain 50 transfers data according to the configuration provided by the control layer blockchain 40 and manages the private key 62.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A system for providing a software defined network comprising multiple blockchain distributed ledgers and communication with artificial intelligence, the system comprising computer readable instructions, the instructions creating and/or communicating with:
a. a management plane blockchain is created that distributes to the network public keys and policies that are voted on and which provides management instructions to a control plane blockchain;
b. the control plane blockchain that configures how to communicate data within the network in response to management instructions from the management plane blockchain;
c. a data plane blockchain that communicates data, including private keys, according to the configuration provided by the control plane blockchain;
d. artificial intelligence that can interact with one or more of the processes of blockchains of the network, including the public keys, the private keys, and any voting process;
e. a quantum random number generator that generates Very Large Numbers that are used for generating at least the public keys and private keys; and
f. wherein the blockchains and/or processes within each blockchain can be controlled by human users, the artificial intelligence, or a combination of human users and artificial intelligence.

2. The system of claim 1 wherein qubits generated by quantum measurements are used in the quantum number generator.

3. The system of claim 1 wherein the quantum random number generator is located in a blockchain of the network.

4. The system of claim 1 wherein the artificial intelligence uses Large Language Models and Retrieval Augmented Generation.

5. A method for providing a software defined network comprising multiple blockchain distributed ledgers and artificial intelligence, the method comprising providing computer readable instructions, the instructions:
a. creating a management plane blockchain that distributes to the network public keys and policies that are voted on and which provides management instructions to a control plane blockchain;
b. creating the control plane blockchain that configures how to communicate data within the network in response to management instructions from the management plane blockchain;
c. creating a data plane blockchain that communicates data, including private keys, according to the configuration provided by the control plane blockchain;
d. communicating with artificial intelligence that can interact with one or more of the processes of blockchains of the network, including the public keys, the private keys, and any voting process;
e. communicating with a quantum random number generator that generates Very Large Numbers that are used for generating at least the public keys and private keys; and
f. wherein the blockchains and/or processes within a blockchain can be controlled by human users, the artificial intelligence, or a combination of human users and artificial intelligence.

6. The method of claim 1 wherein qubits generated by quantum measurements are used in the quantum number generator.

7. The method of claim 1 wherein the quantum random number generator is located in a blockchain of the network.

8. The method of claim 1 wherein the artificial intelligence uses Large Language Models and Retrieval Augmented Generation.

9. A computer program product for providing a software defined network comprising multiple blockchain distributed ledgers and communication with artificial intelligence, the product comprising computer readable instructions, the instructions creating and/or communicating with:
a. a management plane blockchain is created that distributes to the network public keys and policies that are voted on and which provides management instructions to a control plane blockchain;
b. the control plane blockchain that configures how to communicate data within the network in response to management instructions from the management plane blockchain;
c. a data plane blockchain that communicates data, including private keys, according to the configuration provided by the control plane blockchain;
d. artificial intelligence that can interact with one or more of the processes of blockchains of the network, including the public keys, the private keys, and any voting process;
e. a quantum random number generator that generates Very Large Numbers that are used for generating at least the public keys and private keys; and
f. wherein the blockchains and/or processes within a blockchain can be controlled by human users, the artificial intelligence, or a combination of human users and artificial intelligence.

10. The product of claim 1 wherein qubits generated by quantum measurements are used in the quantum number generator.

11. The product of claim 1 wherein the quantum random number generator is located in a blockchain of the network.

12. The product of claim 1 wherein the artificial intelligence uses Large Language Models and Retrieval Augmented Generation.
